(19) United States
(12) Patent Application Publication
(10) Pub. No.: US 2014/0095355 A1
(43) Pub. Date: Apr. 3, 2014

(54) Platform, Method, and Device for Managing Application

(71) Applicant: Huawei Technologies Co., Ltd., Shenzhen (CN)

(72) Inventors: Zhihong Qiu, Shenzhen (CN); Youliang Yan, Shenzhen (CN); Hongbo Jin, Shenzhen (CN); Wangbin Zhu, Shenzhen (CN)

(73) Assignee: Huawei Technologies Co., Ltd., Shenzhen (CN)

(21) Appl. No.: 14/091,738

(22) Filed: Nov. 27, 2013

Related U.S. Application Data
(63) Continuation of application No. PCT/CN2011/083553, filed on Dec. 6, 2011.

(30) Foreign Application Priority Data
May 30, 2011 (CN) 201110142775.9

(51) Int. Cl. G06Q 30/06

(52) U.S. Cl. CPC G06Q 30/0613
USPC 705/26.41

(57) ABSTRACT

The present invention discloses a platform, method, and device for managing an application, and belongs to the field of the Internet. The platform includes a mall and a store, where the mall includes: a management module configured to record and maintain information of an application store, application information, and user information; an application store creation module configured to create the application store according to store implementation logic, so that the application store presents an application according to the implementation logic; and a transaction management module configured to complete billing and charging of the application according to information maintained by the management module; and the store includes: a store interface management module configured to manage and present the application, so that the application is presented in a set presentation manner.

### CROSS-REFERENCE TO RELATED APPLICATIONS

This application is a continuation of International Application No. PCT/CN2011/083553, filed on Dec. 6, 2011, which claims priority to Chinese Patent Application No. 201110142775.9, filed on May 30, 2011, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the field of Internet technologies, and in particular, to a platform, method, and device for managing an application.

### BACKGROUND

An application store is an important technology for publishing applications in the Internet, especially in the mobile Internet. A developer can upload and publish an application developed by the developer to a page of the application store; and a user can browse, buy, and download a needed application on the page of the application store.

Currently, the application store centralizes applications uploaded and published by all developers on the same page, and presents the applications on the page by categories of the applications, rankings of download counts, and so on. A great part of applications presented on the page are network applications; however, the network applications cannot be run individually when being downloaded by a user to a client, but need to be run in coordination with a server.

It can be known from the foregoing that, an existing application store is limited in a presentation manner of applications uploaded and published by developers, and cannot provide a corresponding service for network applications.

### SUMMARY

Embodiments of the present invention provide a platform, method, and device for managing an application. The technical solutions are described as follows:

A platform for managing an application is provided, where the platform includes: an application mall and an application store, where the application mall provides an access interface for the application store, so that a user enters the application store through the access interface, and the application mall includes: a management module configured to record and maintain application store information, application information, and user information; an application store creation module configured to create the application store according to store implementation logic, so that the application store presents an application according to the implementation logic; and a transaction management module configured to complete billing and charging of an application according to information maintained by the management module; and the application store includes: a store interface management module configured to manage and present the application, so that the application is presented in a set presentation manner.

A method for creating an application store in an application mall of a platform is provided, where the method includes: obtaining store implementation logic of an application store; and running the store implementation logic to obtain the application store.

An application mall is provided, where the application mall includes: an obtaining module and a running module, where the obtaining module is configured to obtain store implementation logic of an application store; and the running module is configured to run the store implementation logic to obtain the application store.

A method for publishing an application in an application mall of a platform is provided, where the method includes: receiving presentation information of an application; and receiving the uploaded application, and presenting the application on a page of an application store according to the presentation information.

An application mall is provided, where the mall includes: a receiving module and a presentation module, where the receiving module is configured to receive presentation information of an application; and the presentation module is configured to receive the application that is uploaded, and present the application on a page of an application store according to the presentation information.

A method for downloading an application in an application mall of a platform is provided, where the method includes: receiving a request for downloading an application, and downloading the application to a client; and completing billing of downloading the application according to a billing rule of the application, and completing charging according to the billing.

An application mall is provided, where the mall includes: a download module and a charging module, where the download module is configured to receive a request for downloading an application, and download the application to a client; and the charging module is configured to complete billing of downloading the application according to a billing rule of the application, and complete charging according to the billing.

A method for running an application in an application mall of a platform is provided, where the method includes: opening an application, and invoking a network service in an application store through an application programming interface, where the network service provides a corresponding service for running of the application; and completing billing on the network service according to a charging rule of the network service, and completing charging according to the billing.

An application mall is provided, where the mall includes: an invoking module and a charging module, where the invoking module is configured to open an application, and invoke a network service in an application store through an application programming interface, where the network service provides a corresponding service for running of the application; and the charging module is configured to complete billing on the network service according to a charging rule of the network service, and complete charging according to the billing.

A method for developing an application in an application mall of a platform is provided, where the method includes: receiving parameter information of an application, and invoking a pre-stored development template through an application programming interface; and creating the application according to the parameter information and according to the development template, and registering the created application to an application mall.

An application store is provided, where the application store includes: a receiving module and a creation module, where the receiving module is configured to receive parameter information of an application, and invoke a pre-stored development template through an application programming interface; and the creation module is configured to create the application according to the parameter information and according to the development template, and register the created application to an application mall.

Through the platform for managing an application provided by the embodiments of the present invention, an implementation manner for creating the application store in the application mall is diversified; in addition, multiple presentation manners may be designed for the application store in the application mall, so that a user can conveniently and visually browse an application in the store. Furthermore, the platform provided by the embodiments of the present invention can provide a corresponding network service for running of an application, and based on an application development template provided by the application store, development of an application becomes diversified.

### BRIEF DESCRIPTION OF THE DRAWINGS

To describe the technical solutions in the embodiments of the present invention more clearly, the following briefly introduces the accompanying drawings for describing the embodiments of the present invention. Apparently, the accompanying drawings in the following description show merely some embodiments of the present invention, and persons of ordinary skill in the art may still derive other drawings from these accompanying drawings without creative efforts.

FIG. 1 is a schematic diagram of a platform for managing an application according to Embodiment 1 of the present invention;

FIG. 2 is a schematic flow chart of a method for creating an application store according to Embodiment 2 of the present invention;

FIG. 2A is a physical diagram of an application mall according to Embodiment 2 of the present invention;

FIG. 2B is a physical diagram of an application store according to Embodiment 2 of the present invention;

FIG. 3 is a schematic flow chart of a method for publishing an application according to Embodiment 3 of the present invention;

FIG. 4 is a schematic flow chart of a method for developing an application according to Embodiment 4 of the present invention;

FIG. 5 is a schematic flow chart of a method for browsing and downloading an application according to Embodiment 5 of the present invention;

FIG. 6 is a schematic flow chart of a method for running an application according to Embodiment 5 of the present invention;

FIG. 7 is a schematic diagram of an application mall according to Embodiment 6 of the present invention;

FIG. 8 is a schematic diagram of an application mall according to Embodiment 7 of the present invention;

FIG. 9 is a schematic diagram of an application mall according to Embodiment 8 of the present invention;

FIG. 10 is a schematic diagram of an application mall according to Embodiment 8 of the present invention; and

FIG. 11 is a schematic diagram of an application store according to Embodiment 9 of the present invention.

### DETAILED DESCRIPTION

To make the objectives, technical solutions, and advantages of the present invention more comprehensible, the following further describes the embodiments of the present invention with reference to the accompanying drawings.

### Embodiment 1

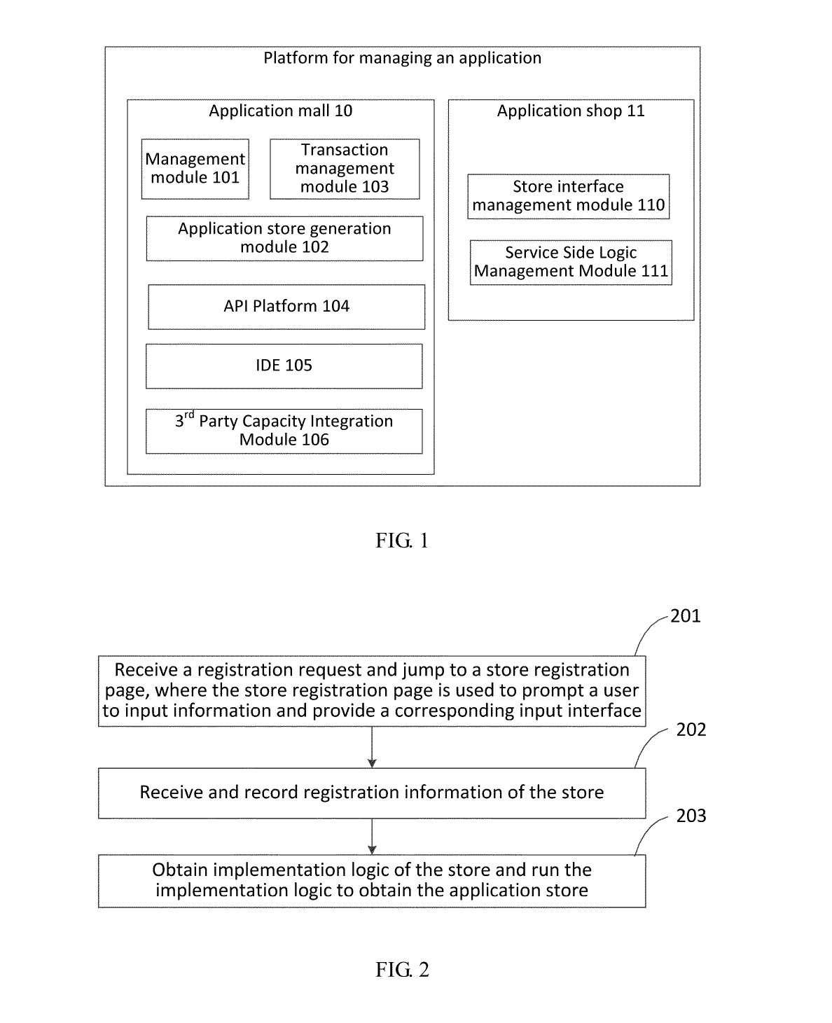

Referring to FIG. 1, a platform for managing an application is provided, where the platform includes: an application mall 10 and an application store 11, where the application mall 10 provides an access interface for the application store 11, so that a user may enter the application store 11 through the access interface; and the application mall 10 includes: a management module 101 configured to record and maintain application store information, application information, and user information; an application store creation module 102 configured to create the application store 11 according to store implementation logic, so that the application store 11 presents an application according to the implementation logic; and a transaction management module 103 configured to complete billing and charging according to information maintained by the management module 101; and the application store 11 includes: a store interface management module 110 configured to manage and present the application, so that the application is presented in a set presentation manner.

Specifically, the management module 101 includes: a store management unit configured to add, delete, or modify the application store information in a database of application store information, where the application store information includes: storekeeper information, a store icon, store introduction, Uniform Resource Locator information of a store, and a billing policy; an application management unit configured to add, delete, or modify the application information in a database of application information, where the application information includes: a program identifier (ID), a program icon, a program developer account, and a program billing mode; and a user information management unit configured to record user information registered in the application mall 10, where the user information includes a user account and a user password; and a user subscription relationship management unit configured to add, delete, or modify a subscription relationship between a user and an application in a database of user subscription relationships.

The application store creation module 102 includes: a first application store creation unit configured to create store implementation logic according to a store logic creation template provided by the application mall 10, and run the store implementation logic in an application mall server to obtain the application store 11; or a second application store creation module configured to run store implementation logic, which is uploaded by a user in advance to an application mall server, in the application mall server to obtain the application store 11; or a third application store creation module configured to invoke, through an application invoking interface, store implementation logic which is uploaded by a user to a user server and run in the user server to obtain the application store 11.

The transaction management module 103 includes: a download transaction management unit configured to perform billing on an application according to the application information recorded by the management module 101 when the application is downloaded, and complete charging according to the billing; and a service transaction management unit configured to perform billing on a network service according to the application information recorded by the management module 101 when the application store 11 provides the network service for running of the application, and complete charging according to the billing.

It should be noted that, the application mall 10 further includes: an application programming interface platform 104 configured to provide an application programming interface, so that the application mall 10 implements information exchange with the application store 11 by invoking the application programming interface; or an application programming interface platform 104 configured to provide an application programming interface, so that the application store 11 provides a network service for the user by invoking the application programming interface; an integrated development environment 105 configured to provide a basic development environment for the platform; and a third-party capacity integration module 106 configured to provide an application invoking interface, so that the application mall obtains a network service of a third party by invoking the application invoking interface.

The store interface management module 110 includes: a store interface presentation platform configured to present and manage an application in the application store 11; and an application presentation logic unit configured to provide support of code logic for a presentation manner of an application in the application store 11.

The application store 11 further includes: a service-side logic management module 111 configured to provide a network service for running of an application when the service-side logic management module 111 is invoked by the application mall 10 through the application programming interface; and an application development module 112 configured to provide support of a development template and a development environment for development of an application in the application store.

The method according to the embodiment of the present invention may be performed by a universal integrated circuit (such as a central processing unit (CPU)) or an application specific integrated circuit (ASIC).

Through the platform for managing an application provided by the embodiment of the present invention, an implementation manner for creating the application store in the application mall is diversified; in addition, multiple presentation manners may be designed for the application store in the application mall, so that a user can conveniently and visually browse an application in the store. Furthermore, the platform provided by the embodiment of the present invention can provide a corresponding network service for running of an application, and based on an application development template provided by the application store, development of an application becomes diversified.

### Embodiment 2

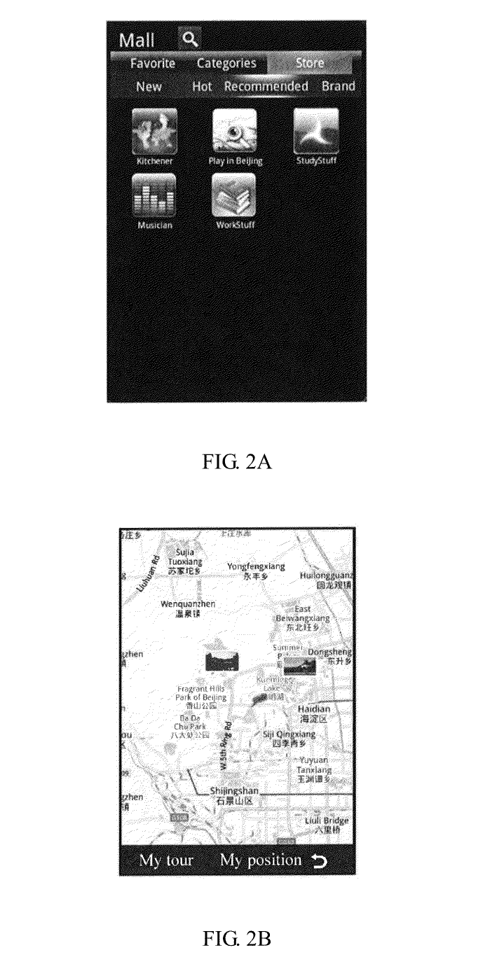

Referring to FIG. 2, step 201 to step 203 provide a method for creating an application store (referred to as a store) in an application mall, and an implementation subject of the method is the application mall (referred to as a mall).

Step 201: Receive a registration request, and jump to a store registration page, where the store registration page is used to prompt a user to input information and provide a corresponding input interface.

Step 202: Receive and record registration information of the store, where the registration information includes information such as store management information and a store presentation manner, and the store management information includes information such as storekeeper information, a store icon, store introduction, a store Uniform Resource Locator (URL), and a billing policy.

The store introduction identifies information such as a type of an application in the store and a type of a service provided in the store, so that a user (including a buyer and a developer) can rapidly obtain store information; the store URL identifies a storage address of running logic of the store; the billing policy includes a charging policy when an application in the store is downloaded, such as, charging according to download counts of the application, charging according to a value added service of the application, and charging according to the use duration of the application; and the billing policy further includes a billing policy when the store is used to provide a service, such as, a charging rule when the store is used to provide a network service for running of the application.

The store presentation manner is used to identify a presented appearance of a page of the store, so that a user can visually diagram an application in the store, for example, when the presentation manner is a map, the page of the store is presented in a map in front of a user.

Specifically, the store management information and the store presentation manner that are filled by the storekeeper in the store registration page are received and recorded, for example, the store registration page provides an optional store icon for a user, so that the user may choose a corresponding store icon according to the taste of the user; the store registration page further provides an application programming interface (API) for the user to upload a store icon, so that the user may upload a favorite store icon; and for example, the store registration page provides an optional store presentation manner for the user, so that the user may select a corresponding store presentation manner according to the taste of the user; and the store registration page may further provide an API for the user to upload a store presentation manner, so that the user may upload a store presentation manner designed by the user.

The step 201 and step 202 are mainly used to obtain store information of a store to be created, so as to manage the store information of the store; and specifically, the mall maintains a database of application store information and maintains the store information by adding, deleting, or modifying the store information in the database of application store information.

Step 203: Obtain implementation logic of the store, and run the implementation logic to obtain an application store, where a page of the created store is presented in recorded store presentation manner.

Specifically, the store may be created in following three manners:

Manner 1: The mall provides implementation logic of the store, where the implementation logic of the store is stored in a server provided by the mall; the implementation logic of the store is obtained from the server provided by the mall; and the implementation logic of the store is run in the server provided by the mall to create a corresponding store.

Manner 2: Implementation logic of the store uploaded by a developer is received, and the received implementation logic of the store is stored in a server provided by the mall; the implementation logic of the store is obtained from the server provided by the mall; and the implementation logic of the store is run in the server provided by the mall to create a corresponding store.

Manner 3: First, it should be noted that, implementation logic of the store is provided by a developer and is stored in a server provided by the developer; therefore, through an API between the mall and the server provided by the developer, the mall invokes the implementation logic of the store, and runs the implementation logic of the store in the server provided by the developer to create a corresponding store.

By applying the method described in the foregoing steps, a user (e.g., a developer or a storekeeper) can create an application store in the application mall, and can design a presentation manner of the store according to the taste of the user; for example, in store management information, if the store introduction is “Play in Beijing”, a selected store icon or an uploaded store icon is a magnifier, and the store presentation manner is a map mode, after implementation logic of the store is run according to the foregoing information, a store shown by the second icon in the first line in FIG. 2A is obtained; and the store icon is used as an entry of the store in the mall, and a store whose presentation manner is a map as shown in FIG. 2B can be opened by clicking the store icon in the mall; and the running logic of the store is stored in an address indicated by a store URL.

In addition, it should be noted that, the application store created through the foregoing steps includes two kinds: the first kind of application store is configured to present, develop, and sell an application, so that a user can rapidly and conveniently browse an application in a store; and the second kind of application store is configured to provide a corresponding network service for running of an application in the first kind of application store, that is, this kind of application store presents and sells server-side logic for running of the application.

Another manner for creating the second kind of application store further exists, which is described as follows:

Existing service logic is directly encapsulated into the second kind of application store, and the mall only needs to provide an API for interconnection between this kind of application store and the application mall.

Specifically, an application interconnected to a real economic entity or another application obtained by encapsulating an existing application needs to be interconnected to existing service logic, for example, an application configured to sell a product needs to be interconnected to an EPR system of a storekeeper, or some video-type applications need to be interconnected to video websites of storekeepers, or a telecommunication-type application needs to be interconnected to an existing telecommunication network; therefore, to provide a service for running of the foregoing applications, the foregoing existing implementation logic such as the EPR system, the video website or the telecommunication network can be encapsulated into the second kind of application stores, and the mall provides an API between service-side logic in the second kind of application stores and the mall.

In the following, a table is taken as an example to illustrate the store management information in the mall after the foregoing steps are performed, which is shown in the following table:

Application mall

| Appli- | | | | | |
|---|---|---|---|---|---|
| cation | Store- | | Intro- | | |
| store | keeper | Icon | duction | URL | Billing policy |
| Store 1 | 000 | Book | Learning | Http:// | Charging according |
| | | | | | to download counts |
| Store 2 | 001 | Magnifier | Play in | Http:// | Charging according |
| | | | Beijing | | to the use duration |
| Store 3 | 002 | Chart | Stock | Http:// | Charging according |
| | | | | | to download counts |
| Store 4 | 003 | Service | Service | Http:// | Charging according |
| | | identity | | | to the number of |
| | | | | | uses |
| . . . | . . . | . . . | . . . | . . . | . . . |

In the following, a table is taken as an example to illustrate a presented appearance of a page of a store created in store presentation manner provided by the mall or in store presentation manner uploaded by a user, which is shown in the following table:

Application mall

| Application store | Presentation manner |
|---|---|
| Store 1 | Shelf |
| Store 2 | Map |
| Store 3 | |
| Store 4 | |
| . . . | . . . |

The method according to the embodiment of the present invention may be performed by a universal integrated circuit (such as a CPU) or an ASIC.

By using the method for creating an application store provided by the embodiment of the present invention, a manner of creating the application store in the application mall is diversified, and the created application store is presented in diversified presentation manner.

### Embodiment 3

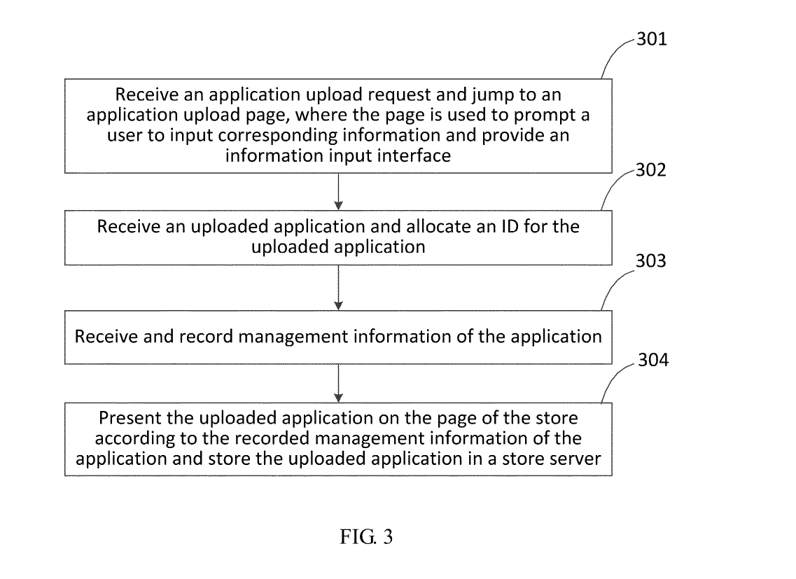

After an application mall creates an application store according to the needs of a user, operations such as developing and publishing an application may be performed in the application store. Referring to FIG. 3, step 301 and step 304 provide a method for publishing an application in the application store, and the implementation subject of the method is the application mall, which is specifically described as follows:

Step 301: Receive an application upload request and jump to an application upload page, where the page is used to prompt a user to input corresponding information and provide an information input interface.

Step 302: Receive an uploaded application and allocate an ID for the uploaded application.

Step 303: Receive and record management information of the application, where the management information includes information such as an icon of the application, a billing mode, and a developer account.

The icon of the application is used to identify a presentation status of the application in the store, so that a user can rapidly obtain information of the application; the billing mode defines a charging standard when the application is used or is downloaded, such as, free of charge, charging according to the use duration, charging according to download counts, and charging according to a value added service; the developer account identifies a developer of the application; and a subscription relationship of a user defines a subscription relationship between the application in the store and the user.

Specifically, management information of the application filled by the user in the application upload page is received and recorded, for example, the application upload page provides an optional application icon for the user, so that the user may select a corresponding application icon according to the taste of the user; and the application upload page further provides an API for the user to upload an application icon, so that the user may upload a favorite application icon.

Step 301 and step 303 are mainly used to obtain application information in the store, so as to manage the application information in the store; and specifically, the mall maintains a database of application information, and implements maintenance of the application information by adding, deleting, or modifying store information in the database of application information.

For example, the application information is shown in the following table:

Application store (Play in Beijing)

| | | Devel- | | |
|---|---|---|---|---|
| | | oper | | |
| Application | ID | account | Icon | Billing mode |
| Application 1 | 000001 | 0002 | Wanshoushan | Free of charge |
| Application 2 | 000010 | 0002 | Imperial Palace | Charging according |
| | | | | to download counts |
| Application 3 | 000011 | 0005 | Shijingshan | Charging according |
| | | | | to the use duration |
| Application 4 | 000110 | 0007 | Huilongguan | Charging according |
| | | | | to download counts |
| . . . | . . . | . . . | . . . | . . . |

It should be noted that, the application information further includes a subscription relationship between the store and a developer, where the subscription relationship may be used to limit an identity of the developer in the store, for example, the application store only accepts an application uploaded by a developer in the subscription relationship, and if another developer that is not in the subscription relationship wants to upload an application in the application store, the developer needs to establish a subscription relationship with the application store, and the application store considers a developer that meets the requirement as a subscriber, for example, considers a developer of which the development level and the credit reach a certain level as a subscriber. In this manner, the quality of the application in the application store can be guaranteed.

Step 304: Present the uploaded application on the page of the store according to the recorded management information of the application, and store the uploaded application in a store server, where the store server distinguishes the application according the allocated ID.

It should be noted that, the store server may be a server provided by the application mall and may also be a server provided by a user.

Specifically, when the application store is created, the presentation manner of the application in the store is set, and the uploaded application is presented on the page of the application store in a set presentation manner.

For example, in the application store “Play in Beijing”, the presentation manner of an application in the store is a map mode, so that the uploaded application is marked in a corresponding position in the map according to a set icon, for example, an application whose icon is “Imperial Palace” is marked in the position of the Imperial Palace in the map.

The foregoing steps provide the method for uploading a developed application to the store in the application mall for presentation. Currently, types of some existing applications, especially some applications interconnected to real economic entities or corporation applications, are always the same, and the difference lies in settings of some parameters. For example, the difference of applications configured to sell tickets of scenic spots may be settings of parameters such as the position of a scenic spot, scenic spot introduction, a picture album of a scenic spot, and a ticket price; in this situation, the application mall or the application store may provide some development modules and corresponding integrated development environments (IDEs), and a developer develops a corresponding application according to the template; in this way, some repeated development actions may be avoided and the efficiency of developing an application is obviously improved.

The method according to the embodiment of the present invention may be performed by a universal integrated circuit (such as a CPU) or an ASIC.

By using the method for presenting an application in the application store provided by the embodiment of the present invention, an application can be presented in the application store in diversified manner, and a user can search for and browse an application in the application store more conveniently.

### Embodiment 4

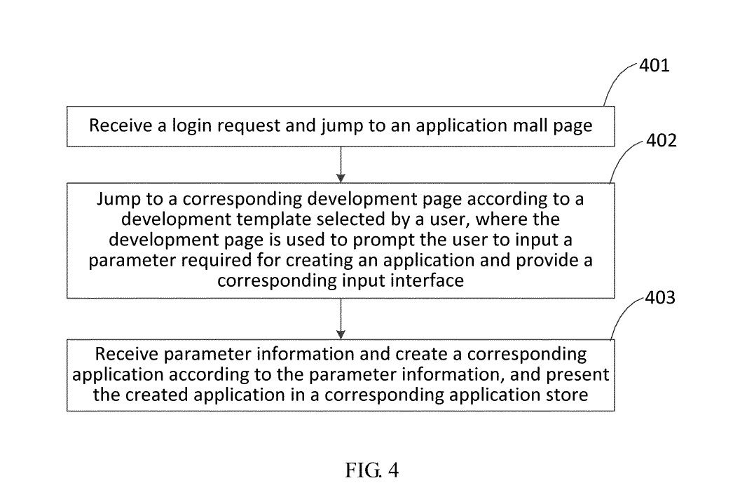

Referring to FIG. 4, a method for developing an application in an application store according to a development template and presenting the developed application is illustrated in detail in the following, and the implementation subject of the method is the application store, which is described as step 401 to step 403:

It should be noted that, before the method is performed, an application mall may further perform the following operations:

Receive a development template registration request, and jump to a development template registration page, where the page is used to prompt a user to input information and provide a corresponding input interface.

Receive and record management information of a development template, where the management information includes information such as template introduction, a store corresponding to the template, and a template link.

Receive an uploaded development template and present the development template in a template page.

The development template includes code creation logic of the application, a page presentation manner of the application in the store, and registration logic for creating the application.

Specifically, a development template uploaded by a developer or a storekeeper is received.

The code creation logic of the application, the page presentation manner of the application in the store, and the registration logic for creating the application are stored in a storage address provided by the template link.

For example, the management information of the development template is shown in the following table:

| | | Store corresponding to | Template |
|---|---|---|---|
| Template | Template introduction | a template | link |
| Template 1 | Telecommunication | Store 1 | Http:// |
| Template 2 | Ticket selling | Store 1 | Http:// |
| Template 3 | Charging | Store 2 | Http:// |
| . . . | . . . | . . . | . . . |

In addition, it should be noted that, the foregoing steps provide a process of registering the development template in the application mall, and in practice, the development template may be further registered in the application store by using the foregoing method, which is not repeated herein.

Step 401: Receive a login request and jump to an application mall interface.

Specifically, a user selects an applicable development module according to the store management information and development module management information that are provided by the application mall.

For example, when an application configured to sell tickets is developed, a development template applicable to create a ticket selling application is selected according to the store information and the development template management information that are provided by the application mall, for example, the template 2 is selected, and the development template 2 provides code logic for creating an application configured to sell tickets.

Step 402: Jump to a corresponding development interface according to a development template selected by a user, where the development interface is used to prompt the user to input a parameter required for creating an application and provide a corresponding input interface.

Step 403: Receive parameter information, create a corresponding application according to the parameter information, and present the created application in a corresponding application store.

Specifically, code creation logic of the application stored in the template link is invoked, and the code creation logic is run according to the input parameter to obtain the corresponding application.

It should be noted that, a user may further adopt the methods described above to register the development template in the application mall; and when the development template is registered in the application mall, a corresponding development template is invoked through an API between the application mall and the application store.

Through the technical solution provided by the embodiment of the present invention, based on an application development template of the application store and according to the development template, development of an application can be diversified, convenient, and fast.

### Embodiment 5

Through the technical solutions provided by Embodiment 2 to Embodiment 4, an application mall with a substantial content is conveniently created, the mall includes various types of application stores, and various applications in each application store are presented in a unique manner. The application mall and the application stores in the mall can provide services, such as browsing, downloading, running, and transaction billing of an application for a user.

The application mall provides user management, application management, subscription relationship management, and billing management for each application store, and further provides a public API opening function for each application store.

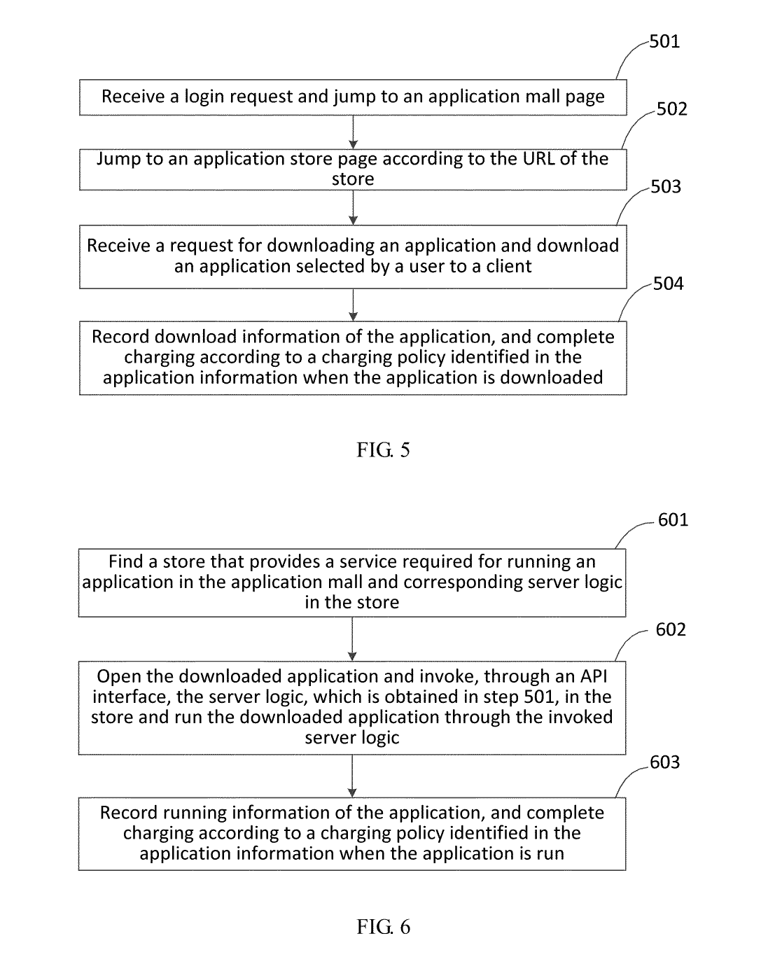

Referring to FIG. 5, procedures of browsing, downloading, and running an application in the foregoing created application store are described in the following; first, step 501 to step 504 provide processes of browsing and downloading an application in an application mall, which are described as follows:

Step 501: Receive a login request and jump to an application mall page, where the application mall provides store management information such as an icon, an introduction, and a URL of each application store in the mall.

A user selects a corresponding application store according to the store management information provided by the application mall page and the needs of the user, and clicks a corresponding URL to open a corresponding application store. For example, when the user needs an application that can provide information relevant to tours, the user obtains, through the store management information provided by the application mall, a store in which an application can provide information relevant to tours, for example, “Play in Beijing”, and clicks a URL of the store to enter the application store.

Step 502: Jump to an application store page according to the URL of the store, where the application store page provides management information such as an icon, an ID, and a billing rule of each application in the store, and the application store page presents an application in the store in the presentation manner designed when the application store is created.

A user selects, according to application information provided by the application store page and an application presented in the application store, an application consistent with the needs of the user, for example, a user selects to download an application whose introduction is “Summer Palace” in the application store.

Step 503: Receive a request for downloading an application and download the application selected by the user into a client.

Step 504: Record download information of the application, and complete charging according to a charging policy identified in application information when the application is downloaded.

It should be noted that, most current applications are network applications and that these kind of network applications cannot be run individually when being downloaded into a client, and a relevant service needs to be performed in coordination with a server, that is, the server provides code logic for running this kind of network applications. For example, when an online game is downloaded to the client, a user cannot experience the online game unless the user is connected to the network, and only in coordination with an online game server, the user can experience the online game downloaded to the client. The application mall provided by the embodiment of the present invention can provide a corresponding service for running of this kind of network applications in the client, that is, one kind of application stores exists in the application mall and service-side logic is presented in the store when various applications are run and a corresponding running service is provided for running of an application.

Referring to FIG. 6, step 601 to step 603 provide a process of running the downloaded application in the application mall as follows:

Step 601: Find a store that provides a service required for running an application in the application mall and corresponding service-side logic in the store by performing the method described in step 501 and step 504.

Step 602: Open the downloaded application, and invoke, through an API, the service-side logic, which is obtained in step 601, in the store, and run the downloaded application by using the invoked service-side logic.

Step 603: Record running information of the application, and complete charging according to a charging policy identified in the application information when the application is run.

An example is taken to describe the process described in step 601 to step 603 as follows:

For example, an application that is downloaded to the client is used for instant communication, and if it intends to accomplish an instant communication function, a call function can be implemented only through a telecommunication server after a telecommunication network is accessed. One kind of application store exists in the application mall provided by the embodiment of the present invention, the store page presents service-side logic of existing services, and service-side logic that provides a call function can be found through store management information and application information in the store, so that the application mall can invoke the service-side logic through a provided open API, run the downloaded application through the invoked service-side logic, and complete corresponding transaction billing, for example, charging according to the use duration of the service-side logic.

The method according to the embodiment of the present invention may be performed by a universal integrated circuit (such as a CPU) or an ASIC.

The embodiment of the present invention provides a charging manner of charging when an application is downloaded and charging when a network provided by the mall is used when running the application.

Through the technical solutions described in Embodiment 2 to Embodiment 5, the implementation manner of the store is diversified, and the division of labor between the platform for managing an application and a user can be flexibly implemented; in addition, multiple presentation manners may be designed for the application store in the application mall, so that the user can more conveniently and visually browse an application in the store; and furthermore, the application store can not only be configured to sell an application, but also provide a corresponding service for running of the application; and the application store can further sell a service that runs the application.

### Embodiment 6

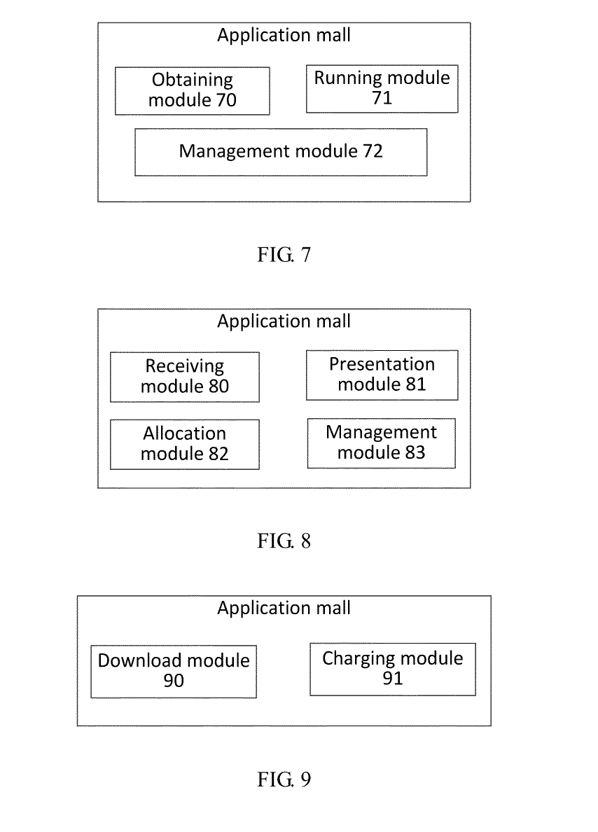

Referring to FIG. 7, an application mall is provided, where the application mall includes: an obtaining module 70 and a running module 71, where the obtaining module 70 is configured to obtain store implementation logic of an application store; and the running module 71 is configured to run the store implementation logic to obtain the application store.

Specifically, the obtaining module 70 includes: a first obtaining unit configured to create store implementation logic according to a store implementation logic creation template provided by the application mall; or a second obtaining unit configured to obtain store implementation logic, which is uploaded by a user in advance to an application mall server, from the application mall server; or a third obtaining unit configured to obtain store implementation logic, which is uploaded by a user in advance to a user server, from the user server.

The running module 71 includes: a first running unit configured to run the store implementation logic in an application server to obtain the application store; or a second running unit configured to invoke, through an application invoking interface, the store implementation logic run in the user server to obtain the application store.

The mall further includes: a management module 72 configured to record management information of the application store, where the management information includes: storekeeper information, a store icon, a store introduction, Uniform Resource Locator information of the store, and a billing policy.

The devices and modules according to the embodiment of the present invention may be a universal integrated circuit (such as a CPU) or an ASIC, and so on.

The method of creating the application store in the application mall is implemented, and the application store is presented in a diversified manner.

### Embodiment 7

Referring to FIG. 8, an application mall is provided, where the mall includes: a receiving module 80 and a presentation module 81, where the receiving module 80 is configured to receive presentation information of an application; and the presentation module 81 is configured to receive the application that is uploaded, and present the application on a page of an application store according to the presentation information.

It should be noted that, the mall further includes an allocation module 82 configured to allocate a program ID for the application.

A management module 83 configured to record management information of the application, where the management information includes: a program ID, a program icon, a program developer account, and a program billing mode.

The method for presenting an application in the application store is implemented, and the application can be presented in a diversified manner in the application store.

### Embodiment 8

Referring to FIG. 9, an application mall is provided, where the mall includes: a download module 90 and a charging module 91, where the download module 90 is configured to receive a request for downloading an application, and download the application to a client; and the charging module 91 is configured to complete billing of downloading the application according to a billing rule of the application, and complete charging according to the billing.

The billing rule of the application can be found in a database of application information maintained by the mall.

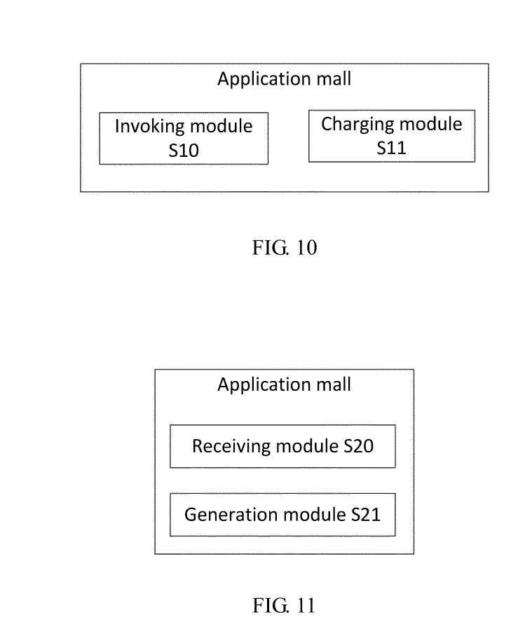

Referring to FIG. 10, an application mall is provided, where the mall includes: an invoking module S10 and a charging module S11, where the invoking module S10 is configured to open an application, and invoke a network service in an application store through an application programming interface, where the network service provides a corresponding service for running of the application; and the charging module S11 is configured to complete billing on the network service according to a charging rule of the network service, and complete charging according to the billing.

The charging rule of the network service can be found in the database of application information maintained by the mall.

This solution implements the method for downloading an application in the application mall and completing the charging, and the method for charging when the network service provided by the mall is used when running the application.

### Embodiment 9

Referring to FIG. 11, an application store is provided, where the application store includes: a receiving module S20 and a creation module S21, where the receiving module S20 is configured to receive parameter information of an application, and invoke a pre-stored development template through an application programming interface; and the creation module S21 is configured to create the application according to the parameter information and according to the development template, and register the created application to an application mall.

This solution implements the method for developing an application based on the application development module, so that development of the application becomes diversified, convenient, and fast.

The devices and modules according to the embodiment of the present invention may be a universal integrated circuit (such as a CPU) or an ASIC, and so on.

The platform for managing an application provided by the embodiment of the present invention includes the application mall and the application store, and the implementation manner of the store is diversified, and the division of labor between the platform for managing an application and a user can be flexibly implemented; in addition, multiple presentation manners can be designed for the application store in the application mall, so that the user can more conveniently and visually browse an application in the store; and furthermore, the application store can not only be configured to sell an application, but also provide a corresponding service for running of the application; and the application store can further sell a service that runs the application.

All or part of the contents in the technical solution provided in the foregoing embodiments may be implemented by software programs, and the software programs are stored in readable storage media such as a computer hard disk, an optical disk, or a floppy disk.

The foregoing descriptions are merely exemplary embodiments of the present invention, but are not intended to limit the present invention. Any modification, equivalent replacement, or improvement made within the spirit and principle of the present invention shall fall within the protection scope of the present invention.

What is claimed is:

1. A platform for managing an application, comprising:
an application mall; and
an application store,
wherein the application mall provides an access interface for the application store such that a user enters the application store through the access interface,
wherein the application mall comprises:
a management module configured to record and maintain application store information, application information, and user information;
an application store creation module configured to create the application store according to store implementation logic, so that the application store presents an application according to the implementation logic; and
a transaction management module configured to complete billing and charging according to information maintained by the management module; and
wherein the application store comprises a store interface management module configured to manage and present the application such that the application is presented in a set presentation manner.

2. The platform according to claim 1, wherein the management module comprises:
a store management unit configured to add, delete, or modify the application store information in a database of application store information, wherein the application store information comprises storekeeper information, a store icon, store introduction, Uniform Resource Locator information of a store, and a billing policy;
an application management unit configured to add, delete, or modify the application information in a database of application information, wherein the application information comprises a program identifier (ID), a program icon, a program developer account, and a program billing mode;
a user information management unit configured to record user information registered in the application mall, wherein the user information comprises a user account and a user password; and
a user subscription relationship management unit configured to add, delete, or modify a subscription relationship between a user and an application in a database of user subscription relationships.

3. The platform according to claim 1, wherein the application store creation module comprises:
a first application store creation unit configured to create store implementation logic according to a store logic creation template provided by the application mall, and run the store implementation logic in an application mall server to obtain the application store; or
a second application store creation module configured to run store implementation logic, which is uploaded by a user in advance to an application mall server, in the application mall server to obtain the application store; or
a third application store creation module configured to invoke, through an application invoking interface, store implementation logic which is uploaded by the user to a user server and run in the user server to obtain the application store.

4. The platform according to claim 1, wherein the transaction management module comprises:
a download transaction management unit configured to perform billing on an application according to the application information recorded by the management module when the application is downloaded, and complete charging according to the billing; and
a service transaction management unit configured to perform billing on a network service according to the application information recorded by the management module when the application store provides the network service for running of the application, and complete charging according to the billing.

5. The platform according to claim 1, wherein the application mall further comprises:
an application programming interface platform configured to provide an application programming interface such that the application mall implements information exchange with the application store by invoking the application programming interface, or, such that the application store provides a network service for the user by invoking the application programming interface;
an integrated development environment configured to provide a basic development environment for the platform; and
a third-party capacity integration module configured to provide an application invoking interface such that the application mall obtains a network service of a third party by invoking the application invoking interface.

6. The platform according to claim 1, wherein the store interface management module comprises:
a store interface presentation platform configured to present and manage an application in the application store; and
an application presentation logic unit configured to provide support of code logic for a presentation manner of an application in the application store.

7. The platform according to claim 1, wherein the application store further comprises:
an application development module configured to provide support of a development template and a development environment for development of the application in the application store; and
a service-side logic management module configured to provide a network service for running of the application when the service-side logic management module is invoked by the application mall through an application programming interface.

8. A method for creating an application store in an application mall of a platform, comprising:
obtaining store implementation logic of an application store; and
running the store implementation logic to obtain the application store.

9. The method according to claim 8, wherein obtaining the store implementation logic of the application store comprises:
creating store implementation logic according to a store implementation logic creation template provided by the application mall; or
obtaining store implementation logic, which is uploaded by a user in advance to an application mall server, from the application mall server; or
obtaining store implementation logic, which is uploaded by the user in advance to a user server, from the user server.

10. The method according to claim 8, wherein running the store implementation logic to obtain the application store comprises:
running the store implementation logic in the application server to obtain the application store; or
invoking, through an application invoking interface, the store implementation logic run in the user server to obtain the application store.

11. The method according to claim 8, further comprising recording management information of the application store, wherein the management information comprises storekeeper information, a store icon, a store introduction, Uniform Resource Locator information of the store, and a billing policy.

12. An application mall, comprising:
an obtaining module; and
a running module,
wherein the obtaining module is configured to obtain store implementation logic of an application store, and
wherein the running module is configured to run the store implementation logic to obtain the application store.

13. The mall according to claim 12, wherein the obtaining module comprises:
a first obtaining unit configured to create store implementation logic according to a store implementation logic creation template provided by the application mall; or
a second obtaining unit configured to obtain store implementation logic, which is uploaded by a user in advance to an application mall server, from the application mall server; or
a third obtaining unit configured to obtain store implementation logic, which is uploaded by the user in advance to a user server, from the user server.

14. The mall according to claim 12, wherein the running module comprises:
a first running unit configured to run the store implementation logic in the application server to obtain the application store; or
a second running unit configured to invoke, through an application invoking interface, the store implementation logic run in the user server to obtain the application store.

15. The mall according to claim 12, further comprising a management module configured to record management information of the application store, wherein the management information comprises storekeeper information, a store icon, a store introduction, Uniform Resource Locator information of the store, and a billing policy.

16. A method for publishing an application in an application mall of a platform, comprising:
receiving presentation information of an application;
receiving the application that is uploaded; and
presenting the application on a page of an application store according to the presentation information.

17. The method according to claim 16, wherein presenting the application on the page of the corresponding application store according to the presentation information comprises:
running store presentation logic according to the presentation information;
presenting the application on the page of the application store; and
storing and running the store presentation logic in a server of the application store.

18. The method according to claim 16, further comprising allocating a program identifier (ID) for the application.

19. The method according to claim 16, further comprising recording management information of the application, wherein the management information comprises a program identifier (ID), a program icon, a program developer account, and a program billing mode.

20. An application mall, comprising:
a receiving module; and
a presentation module,
wherein the receiving module is configured to receive presentation information of an application, and
wherein the presentation module is configured to receive the application that is uploaded, and present the application on a page of an application store according to the presentation information.

21. The mall according to claim 20, further comprising an allocation module configured to allocate a program identifier (ID) for the application.

22. The mall according to claim 20, further comprising a management module configured to record management information of the application, wherein the management information comprises a program identifier (ID), a program icon, a program developer account, and a program billing mode.

23. A method for downloading an application in an application mall of a platform, comprising:
receiving a request for downloading an application;
downloading the application to a client;
completing billing of downloading the application according to a billing rule of the application; and
completing charging according to the billing.

24. The method according to claim 23, wherein the billing rule comprises charging according to download counts of the application, charging according to the use duration of the application, and charging according to a value added service of the application.

25. An application mall, comprising:
a download module; and
a charging module,
wherein the download module is configured to receive a request for downloading an application, and download the application to a client, and
wherein the charging module is configured to complete billing of downloading the application according to a billing rule of the application, and complete charging according to the billing.

26. A method for running an application in an application mall of a platform, comprising:
opening an application, and invoking a network service in an application store through an application programming interface, wherein the network service provides a corresponding service for running of the application; and
completing billing on the network service according to a charging rule of the network service, and completing charging according to the billing.

27. The method according to claim 26, wherein the charging rule comprises charging according to the use duration of the network service, charging according to a value added service of the network service, and charging according to the number of uses of the network service.

28. An application mall, comprising:
an invoking module; and
a charging module,
wherein the invoking module is configured to open an application, and invoke a network service in an application store through an application programming interface,
wherein the network service provides a corresponding service for running of the application, and
wherein the charging module is configured to complete billing on the network service according to a charging rule of the network service, and complete charging according to the billing.

29. A method for developing an application in an application store of a platform, comprising:
receiving parameter information of an application, and invoking a pre-stored development template through an application programming interface; and
creating the application according to the parameter information and according to the development template, and registering the created application to an application mall.

30. An application store, comprising:
a receiving module; and
a creation module,
wherein the receiving module is configured to receive parameter information of an application, and invoke a pre-stored development template through an application programming interface, and
wherein the creation module is configured to create the application according to the parameter information and according to the development template, and register the created application to an application mall.
